(19) United States
(12) Patent Application Publication
(10) Pub. No.: US 2026/0056115 A1
(43) Pub. Date: Feb. 26, 2026

(54) MEASURING CELL

(71) Applicant: Endress+Hauser Conducta GmbH+Co. KG, Gerlingen (DE)

(72) Inventors: Andreas Müller, Ostfildern (DE); Hans Meyer, Eschach (DE); Thilo Krätschmer, Gerlingen (DE); Matthias Großmann, Vaihingen-Enz (DE)

(21) Appl. No.: 19/305,907

(22) Filed: Aug. 21, 2025

(30) Foreign Application Priority Data
Aug. 22, 2024 (DE) 10 2024 124 093.8

(51) Int. Cl. G01N 21/01

(52) U.S. Cl. CPC G01N 21/01; G01N 2021/0106

(57) ABSTRACT

A measuring cell for a measuring apparatus for optically measuring a parameter of a medium comprises two half-shells and at least one window. The half-shells each have a recess on their mutually facing inner sides, each of which forms one half of a channel running through the measuring cell. The half-shells are connected to one another by two joints arranged on opposite sides of the channel and directly adjacent to the channel over the entire length of the channel. Each window is either formed by a transparent region of one of the half-shells adjacent to the measuring portion of the channel or is enclosed in one of the half-shells without any gap, with or without the interposition of a seal, in such a way that it seals with the front flush on an inner surface of the corresponding half-shell adjacent to the measuring portion of the channel.

### CROSS-REFERENCE TO RELATED APPLICATION

The present application is related to and claims the priority benefit of German Patent Application No. 10 2024 124 093.8, filed on Aug. 22, 2024, the entire contents of which are incorporated herein by reference.

### TECHNICAL FIELD

The invention relates to a measuring cell with a channel running through the measuring cell and through which a medium can flow, and at least one window.

### BACKGROUND

Measuring cells with a channel through which the medium can flow and at least one window are used, for example, in measuring apparatuses for the optical measurement of at least one parameter of the medium flowing through the channel.

DE 10 2013 101 196 A1 describes a measuring apparatus for carrying out optical measurements, which comprises a measuring cell designed as a flow cell block of stainless steel. The flow cell block comprises an inner chamber, connected to a channel on the inlet side and on the outlet side, and two ducts arranged opposite one another perpendicular to the flow direction. A window is clamped in each duct with the interposition of a seal in such a way that a portion of the window projects into the inner chamber of the flow cell block. The measuring apparatus comprises a transmitting device mountable on the flow cell block by means of which transmitted radiation is transmitted through one of the two windows into the medium located between the two windows, and a detector which receives the measurement radiation emerging from the opposite window resulting from an interaction of the transmitted radiation along an optical path running through the medium. The path length of the optical path along which the interaction with the medium takes place corresponds to the distance between the windows opposite one another. This path length is adjustable according to the measuring apparatus described in DE 10 2013 101 196 A1 by the windows being inserted with spacers interposed, which can be selected from a group of spacers of different size. This offers the advantage that the insertion depth of the windows and therefore also the optical path length can be adjusted in stages via the selection of the spacers.

However, the disadvantage is that the seals required to seal the gaps between the windows and the ducts come into contact with the medium inside the flow cell block. This is particularly disadvantageous in locations where strict hygiene requirements exist, as it poses the risk of contamination. In addition, seals age and should therefore be replaced regularly.

A further disadvantage is that the shorter the optical path length corresponding to the distance between the windows, the further the windows extend into the interior of the flow cell blocks. The windows therefore represent obstacles that hinder the flow of the medium through the flow cell block. As a result, eddies and/or turbulences can arise which, under certain circumstances, can lead to impairments of the measurements and/or can have a negative effect on the medium. Accordingly, eddies and/or turbulences can, for example, lead to bubbles forming in the medium which impair the measurement. In addition, shearing forces can be exerted on the medium by eddies and/or turbulences. The latter can lead to damage to the medium especially in biotechnological applications in which the medium contains components sensitive to shear forces, such as cell cultures, for example. A further problem is caused by dead volumes due to portions of the windows protruding into the inner chamber, which take up medium but through which the medium does not flow at all or only at a lower speed than other segments of the internal volume of the measuring cell through which the medium flows. Eddies, turbulence and/or dead volumes can lead to components of the medium having different properties, such as different densities flowing through the measuring cell at different speeds, and/or mixing of partial volumes of the medium entering the measuring cell in succession. Both lead to impairments of the measurements and of the medium.

WO2019/185678 A1 describes a measuring cell equipped with windows for carrying out optical measurements, through the main body of which runs a channel through which the medium can flow. The main body comprises two outer plates between which two main metal elements are arranged, screwed together.

The first main element has outer wall regions parallel to the longitudinal axis of the channel, through each of which an outer channel portion of the channel runs. The second main element has a front region which is inserted into the first main element through an opening of the first main element arranged between the two outer channel portions in such a way that a central channel region connecting the two outer channel portions to one another is arranged between the front region of the second main element and a region of the first main element opposite the front region.

The central channel region comprises a first shape-change portion, the cross-sectional area of which transitions from a circular shape of the inlet-side outer channel portion to an elongated hole shape in the longitudinal direction running parallel to the longitudinal axis of the channel, and a diffuser portion following the shape-change portion in the longitudinal direction and having a cross-sectional area which has an elongated hole shape and which increases in the longitudinal direction. The diffuser portion is followed by a measuring portion arranged between two windows inserted into the main elements, a reduction portion designed mirror-symmetrically to the diffuser portion and a second shape-change portion, the cross-sectional area of which changes in the longitudinal direction from the elongated hole shape of the reduction portion into a circular shape of the outlet-side outer channel portion.

The windows, which are inserted with the front flush in the passage openings of the two main elements adjacent to the measuring portion, and the continuous changes in the cross-sectional area of the channel in the longitudinal direction offer the advantage of avoiding dead volumes. However, both the longitudinally increasing cross-sectional area of the diffuser portion and the longitudinally decreasing cross-sectional area of the reduction portion lead to changes in the flow velocity of the medium flowing through the channel. However, this effect, which is specifically used in WO2019/185678 A1 to slow down the flow velocity of the medium in the measuring portion, can lead to components of the medium having different properties, such as different densities, flowing through the measuring cell at different speeds, and/or to mixing of partial volumes of the medium entering the measuring cell one after the other. Both lead to impairments of the measurements and of the medium.

To seal the channel, the second main element has, on its rear side facing away from the channel, an edge region projecting outwards relative to the front region and which rests on a region of the first main element which surrounds the opening in the first main element on all sides on the outside. The region has a groove on its side facing away from the channel, in which a seal is seated between the region of the first main element and the edge region of the second main element. This seal also ages and should therefore be replaced regularly. In addition, there is a risk that medium will penetrate into the gap running between the two main elements from the channel to the seal arranged on the side of the region of the first main element facing away from the channel. This can lead to contamination, which is particularly problematic in applications such as biotechnological applications, where hygiene requirements are strict.

In addition, the manufacture and assembly of the measuring cell described in WO2019/185678 A1 is comparatively complex due to the large number of components of the measuring cell that have to be manufactured individually and mechanically connected by fastening means, such as screw connections. The measuring cell is therefore unsuitable as a disposable measuring cell, in particular for cost reasons.

### SUMMARY

It is an object of the invention to provide a measuring cell for a measuring apparatus for the optical measurement of at least one parameter of a medium, which meets strict hygiene requirements.

For this purpose, the invention comprises a measuring cell for a measuring apparatus for the optical measurement of a parameter of a medium having two half-shells and at least one window, wherein:
the half-shells each have a recess on their mutually facing inner sides,
the adjacent, opposite recesses each form one half of a channel running through the measuring cell,
the channel comprises a measuring portion which is arranged in a direction running parallel to a longitudinal axis of the channel, between two outer channel portions of the channel, and is connected to each outer channel portion by a connecting portion of the channel designed as a cross-section converter,
the half-shells are connected to one another by two joints arranged on opposite sides of the channel, each directly adjacent to the channel over the entire length of the channel, and
each window is either formed by a transparent region of one of the half-shells adjacent to the measuring portion or is enclosed in one of the half-shells without any gap, with or without the interposition of a seal, in such a way that it seals with the front flush on an inner surface of the corresponding half-shell adjacent to the measuring portion of the channel.

The measuring cell offers the advantage that it meets strict hygiene requirements, particularly due to the joints, as it has no gaps adjacent to the channel that could come into contact with the medium in the channel. In view of the strict hygiene requirements, the windows are preferably formed by a transparent region of one of the half-shells or are enclosed in one of the half-shells without any gap and without the interposition of a seal. This offers the advantage that they do not contain any seals that could come into contact with the medium and need to be replaced.

In addition, the measuring cell has the advantage that it has very few components and can be manufactured cost-effectively. This offers the advantage that the measuring cell can also be used in particular as a cost-effective disposable measuring cell.

A further advantage is that the channel does not comprise any dead volumes and the shape of the channel largely avoids eddies and turbulence. This offers the advantage that a homogeneous flow profile of the medium flowing laminarly through the measuring cell is achieved.

In one design, the half-shells:
are designed as one-piece elements,
are made of metal, stainless steel, plastics material, polyetheretherketone, polyphenylenesulfone or a transparent material, polycarbonate, cyclo-olefin copolymer, glass or quartz glass, and/or
are designed as injection-molded parts or as 3D-printed parts.

In further embodiments,
a) on both sides of the channel, the end faces of the two half-shells, which are adjacent to one another in pairs, are connected to one another by means of adhesives, ultrasonic welding or friction welding, or by means of joints made with a thermal joining process,
b) the joints adjacent to the outside of the channel on both sides are each formed as laser welds produced by a laser introduced into the channel, or
c) each of the joints adjacent to the channel on the outside on both sides is designed as a joint produced from the outside of the measuring cell, as a joint produced from the outside of the measuring cell by means of a thermal joining process, or as a weld or laser weld produced from the outside of the measuring cell with a welding device, which extends as far as the channel.

In further embodiments, each of the joints adjacent to the channel on both sides is designed as a joint produced from the outside of the measuring cell, wherein:
the end faces connected in pairs by the joints produced from the outside have a width running perpendicular to the longitudinal axis of the channel which is less than or equal to a maximum width predetermined depending on the material of the half-shells and the joining process used, which is dimensioned such that the joints produced from the outside are adjacent to the channel in the interior of the measuring cell, and/or
the half-shells have recesses which are adjacent to their end faces on the outside and are dimensioned such that the width of the end faces of the half-shells which are adjacent to the channel on the outside is constant and/or less than or equal to the maximum width over the entire length of the channel.

In further embodiments,
the two half-shells are designed as half-shells of the same shape, the end faces of which are connected to one another in pairs by one of the joints and are designed as planar surfaces, or
the half-shells have, on their mutually facing end faces, mutually complementary alignment elements or alignment elements designed as mutually complementary plug-in connector elements, which engage with a positive connection when the two half-shells rest on one another in such a way that the recesses forming one half of the channel each are adjacent to one another with an exact fit.

In further embodiments,
the outer channel portions have identical circular cross-sectional areas and/or cross-sectional areas of constant size in a direction running parallel to the longitudinal axis of the channel, and/or have an inner diameter in the range of 2 mm to 26 mm,
the connecting portions are designed such that their cross-sectional area, in a direction running parallel to the longitudinal axis of the channel from the outer channel portion adjacent to the corresponding connecting portion to the measuring portion, continuously transitions from the cross-sectional area of the adjacent outer channel portion into a cross-sectional area of the adjacent measuring portion, and/or
the measuring portion has a shape permitting laminar flow, has a shape free of dead spaces and/or has a cross-sectional area which does not change at all or at least only changes continuously in the direction running parallel to the longitudinal axis of the channel.

In a further embodiment, a cross-sectional area of the channel in the direction running parallel to the longitudinal axis of the channel has a constant size over the entire length of the channel.

In further embodiments, the measuring cell comprises two windows arranged opposite one another on both sides of the measuring portion, wherein the windows are arranged at a distance from one another which:
corresponds to a path length of an optical path running through the measuring portion,
is within a distance range from 0.5 mm to 20 mm, from 0.5 mm to 10 mm, from 0.5 mm to 8 mm, from 0.5 mm to 5 mm or from 0.5 mm to 3 mm and/or
is smaller than an inner diameter of the outer channel portions.

A first embodiment variant consists in that each window is formed as an individual part from a transparent material, from glass, from quartz glass, from sapphire or from a transparent plastics material, and is inserted with the front flush by means of a press fit into a passage opening of one of the half-shells adjacent to the measuring portion.

In versions of the first embodiment variants:
a) each window is designed as a cylindrical element or as an element having a shape that can be installed by means of a press fit, and the half-shells are made of plastics material, or
b) each window is designed as a conical element or as an element having a shape that can be installed by means of a press fit, and is made of sapphire or of a transparent material that is harder than a metal or a stainless steel from which the half-shells are made.

A second embodiment variant consists in that the half-shells are formed as injection-molded parts and each window is formed as an individual part made of glass, quartz glass, sapphire or a transparent material and overmolded during the production of one of the half-shells.

In versions of the second embodiment variant, each window:
a) is designed as an overmolded and/or substantially cylindrical or conical element,
b) has at least one bulge projecting on the outside and/or surrounding a cylindrical region of the window on all sides, and/or
c) has at least one notch on the outside and/or comprises a cylindrical region which has at least one or more notches on the outside, each designed as an annular circumferential groove.

Furthermore, the invention comprises a method for producing measuring cells according to the invention, wherein the half-shells are produced and subsequently connected to one another by a joining process with which the joints adjacent to the channel are produced.

One embodiment of the method consists in that the windows are prefabricated and are either overmolded during the production of the half-shells designed as injection-molded parts or are inserted into passage openings of the half-shells by means of a press fit after the production of the half-shells before the joining process is carried out.

The invention furthermore comprises a measuring apparatus having a measuring cell according to the invention, which

comprises a measuring cell receptacle into which the measuring cell can be inserted or is inserted, and

comprises a sensor for measuring at least one parameter of the medium located in the measuring portion of the channel of the measuring cell or flowing through the measuring portion, wherein the sensor:
a) is designed as an optical sensor, as a turbidity sensor, as a sensor for measuring a solids concentration in the medium, as a fluorescence sensor, as an absorption sensor, as a sensor for measuring a spectral absorption of the medium at one or more wavelengths, or a concentration of an analyte in the medium, and/or
b) comprises a transmitting device and a measuring device, wherein:
the transmitting device comprises at least one radiation source and is designed and arranged such that, during measuring operation, it transmits transmitted radiation through a window of the measuring cell into the measuring portion, and
the measuring device comprises a detector which is designed and arranged in such a way that, during measuring operation, it receives measurement radiation emerging through a window of the measuring cell resulting from an interaction of the transmitted radiation with the medium located in the measuring portion, and provides a parameter-dependent measurement signal to an evaluation device integrated in the measuring device or connected or connectable to the measuring device and which is designed to determine and provide a measuring result of the parameter(s) based on measuring signals.

### BRIEF DESCRIPTION OF THE DRAWINGS

The invention and its advantages will now be explained in detail using the figures in the drawing, which show several examples of embodiments. The same elements are indicated by the same reference numbers in the figures.

FIG. 1 shows a partially cutaway view of a measuring cell;

FIG. 2 shows a longitudinal section of the measuring cell of FIG. 1;

FIG. 3 shows a cross section of the measuring cell of FIG. 1;

FIG. 4 shows a measuring cell with transparent half-shells in a sectional plane running through a measuring portion;

FIG. 5 shows the measuring cell of FIG. 4 in a sectional plane running through an outer channel portion;

FIG. 6 shows a measuring cell with overmolded windows and joints produced from the inside;

FIG. 7 shows a measuring cell with joints produced from the outside;

FIG. 8 shows the measuring cell of FIG. 7 in a sectional plane running through an outer channel portion; and

FIG. 9 shows a measuring apparatus having a measuring cell.

### DETAILED DESCRIPTION

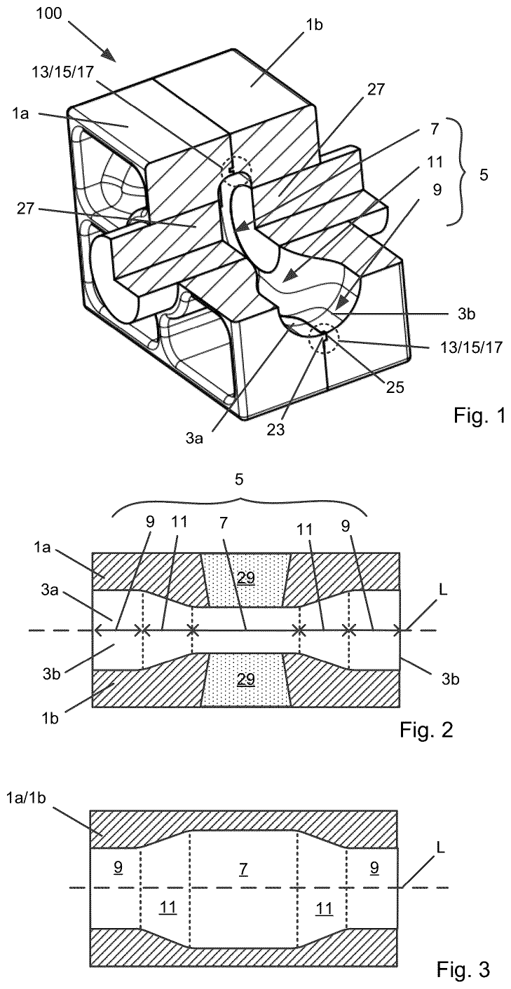

FIG. 1 shows a partially cutaway view of a measuring cell 100 for a measuring apparatus for the optical measurement of a parameter of a medium.

The measuring cell 100 comprises two half-shells 1a, 1b connected to one another, each of which has a recess 3a, 3b on the mutually facing end faces. The adjacent, opposite recesses 3a, 3b in the measuring cell 100 are designed such that they each form one half of a channel 5 running through the measuring cell 100.

The half-shells 1a, 1b are preferably designed as one-piece elements and consist, for example, of a metal, such as stainless steel, of a plastics material, such as polyetheretherketone (PEEK) or polyphenylenesulfone (PPSU), or of a transparent material, such as polycarbonate (PC), cyclo-olefin copolymer (COC), or a glass, such as quartz glass. Alternatively or additionally, the half-shells 1a, 1b are designed, for example, as injection-molded parts or as 3D-printed parts. An advantageous embodiment, particularly with regard to the use of the measuring cell 100 as a disposable measuring cell, consists in the fact that the half-shells 1a, 1b are designed as injection-molded parts made of plastics material.

The channel 5 comprises a measuring portion 7 which is arranged in a direction running parallel to a longitudinal axis L of the channel 5 between two outer channel portions 9 of the channel 5. The measuring portion 7 is connected to each outer channel portion 9 by a connecting portion 11 of the channel 5 designed as a cross-section converter.

FIG. 2 shows a longitudinal section of the measuring cell 100 of FIG. 1 in a sectional plane running perpendicular to the mutually facing end faces of the two half-shells 1a, 1b. FIG. 3 shows a cross section of the measuring cell 100 in a sectional plane running between the end faces of the two half-shells 1a, 1b.

The individual portions of the channel 5 can be formed in different ways by appropriately shaping the recesses 3a, 3b. In this case, one of the two outer channel portions 9 is designed, for example, as an inlet, which can be connected to a supply line not shown in the drawings, via which the medium can be supplied to the measuring cell 100. Analogously, the other outer channel portion 9 is designed, for example, as an outlet, which can be connected to a discharge line not shown in the drawings, via which the medium emerging from the measuring cell 100 through the outlet can be discharged.

In this respect, the outer channel portions 9, for example, have identical circular cross-sectional areas, the size of which is preferably constant in the direction running parallel to the longitudinal axis of the outer channel portions 9. Alternatively or additionally, the cross-sectional areas Ak of the outer channel portions 9 are preferably dimensioned in such a way that they are greater than or equal to a minimum surface, for example greater than or equal to a minimum surface area due to manufacturing tolerances, and/or greater than or equal to a minimum surface defined by a cross-sectional area of the supply line and/or the discharge line. In this respect, the outer channel portions 9 have, for example, an inner diameter in the range of several millimeters, e.g., an inner diameter of 2 mm to 26 mm.

The connecting portions 11 are each designed as cross-section converters, for example, such that their cross-sectional area, in a direction running parallel to the longitudinal axis L of the channel 5 from the outer channel portion 9 adjacent to the corresponding connecting portion 11 to the measuring portion 7, continuously transitions from the cross-sectional area of the adjacent outer channel portion 9 into a cross-sectional area of the adjacent measuring portion 7.

Alternatively or additionally, the measuring portion 7 is designed, for example, in such a way that it has a shape permitting laminar flow, has a shape free of dead spaces and/or has a cross-sectional area which does not change at all or at least only changes continuously, in particular only to a small extent, in the direction running parallel to the longitudinal axis L of the channel 5.

Optionally, the measuring portion 7, the outer channel portions 9 and the connecting portions 11 are designed, for example, such that the cross-sectional area of the channel 5 in the direction running parallel to the longitudinal axis L of the channel 5 has a constant size over the entire length of the channel 5. This optional embodiment offers the advantage that different flow rates of components of the medium which have different properties, such as different densities, as well as mixing of volumes of the medium entering the measuring cell 100 one after the other in time, are largely avoided. Depending on the intended use of the measuring cell 100, the channel 5 can also be designed such that the size of the cross-sectional areas varies at least in sections in the direction running parallel to the longitudinal axis L of the channel 5.

Irrespective of the corresponding design of the channel 5, the two half-shells 1a, 1b are connected to one another by two joints 13, 15, 17 arranged on opposite sides of the channel 5 and directly adjacent to the channel 5 over the entire length of the channel 5, such as adhesive joints or joints produced by thermal joining processes, such as welds.

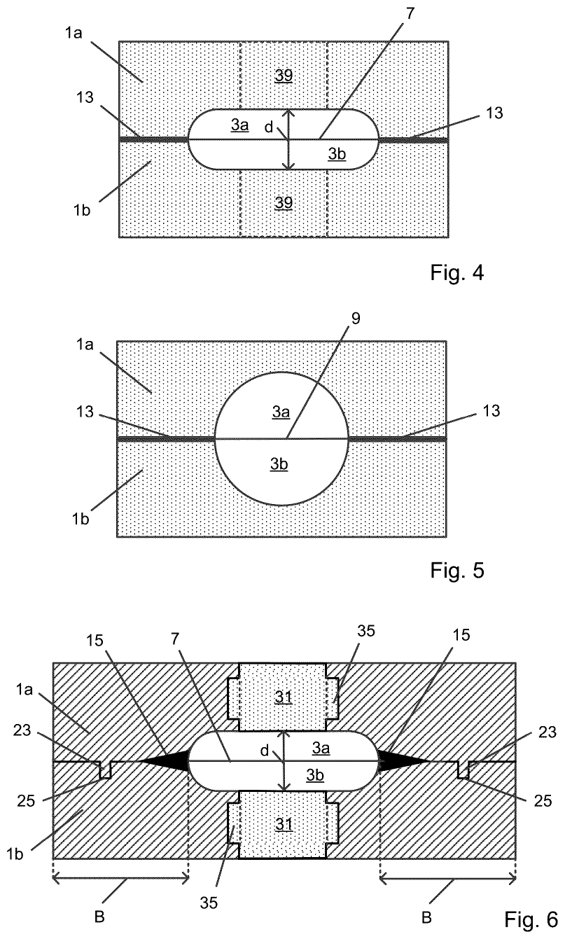

FIGS. 4 and 5 show an embodiment of a measuring cell 100 designed in the manner described above, in which the end faces of the two half-shells 1a, 1b, which are adjacent to one another in pairs on both sides of the channel 5, are each connected to one another by one of the two joints 13. This embodiment is shown in FIG. 4 in a sectional plane running through the measuring portion 7 and in FIG. 5 in a sectional plane running through one of the two outer channel portions 9.

In this embodiment, the joints 13 are formed, for example, as adhesives, as friction welds or as ultrasonic welds. This embodiment offers the advantage that both joints 13 can be produced simultaneously in a single joining process. Depending on the choice of joining process, the end faces of the two half-shells 1a, 1b, which are adjacent to one another in pairs, are connected to one another, for example, over the entire surface or at least almost over the entire surface, by one of the two joints 13 adjacent to the channel 5. This embodiment, which is particularly advantageous in conjunction with joints 13 designed as adhesives, is shown in FIGS. 4 and 5. Alternatively, depending on the choice of joining process, the measuring cell 100 is designed, for example, such that only limited partial surfaces of the adjacent end faces of the two half-shells 1a, 1b, which are directly adjacent to the channel 5, are connected to one another in pairs by one of the two joints adjacent to the channel 5.

FIG. 6 shows a sectional drawing of a further embodiment of a measuring cell 100 designed in the manner described above in a sectional plane running through the measuring portion 7, in which the joints 15 adjacent to the outside of the channel 5 on both sides are each designed as laser welds produced by a laser introduced into the channel 5. This embodiment is particularly advantageous when the end faces connected to one another in pairs by the joints 15 produced from the inside have a large width B running perpendicular to the longitudinal axis L of the channel 5.

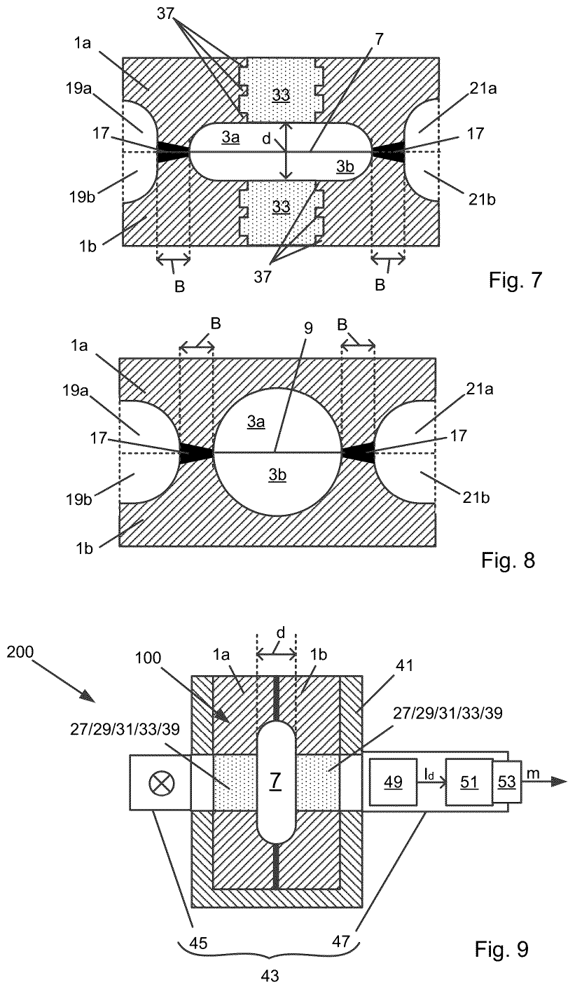

FIGS. 7 and 8 show a further embodiment of a measuring cell 100 designed in the manner described above, in which the joints 17 adjacent to the channel 5 on both sides are each designed as joints 17 produced from the outside of the measuring cell 100 and each extending as far as the channel 5. This embodiment is shown in FIG. 7 in a sectional plane running through the measuring portion 7 and in FIG. 8 in a sectional plane running through one of the two outer channel portions 9. The joints 17 are each formed, for example, as joints 17 produced from the outside of the measuring cell 100 by means of a thermal joining process, such as a welding process. In this respect, the joints 17 are designed, for example, as welds produced with a welding device, such as laser welds. This embodiment is particularly advantageous when the half-shells 1a, 1b are made of a metal.

In the embodiment shown in FIGS. 7 and 8, the end faces connected to one another in pairs by the joints 17 produced from the outside preferably have a width B running perpendicular to the longitudinal axis L of the channel 5 which is less than or equal to a maximum width predetermined depending on the material of the half-shells 1a, 1b and the joining process used, by which it is ensured that the joints 17 produced from the outside are adjacent to the channel 5 in the interior of the measuring cell 100.

This small width B can be achieved, for example, by a corresponding dimensioning of a total width of the half-shells 1a, 1b running perpendicular to the longitudinal axis L of the channel 5. Alternatively or additionally, the correspondingly small width B is achieved, for example, in the manner shown in FIGS. 7 and 8, for example, in that the half-shells 1a, 1b have recesses 19a, 19b, 21a, 21b which are adjacent to their end faces on the outside and which delimit the width B of the end faces. In this case, the dimensions of the recesses 19a, 19b, 21a, 21b are such that the width B of the end faces of the half-shells 1a, 1b adjacent to the outside of the channel 5 is less than or equal to the maximum width over the entire length of the channel 5. The dimensions of the recesses 19a, 19b, 21a, 21b are, for example, such that the width B of the end faces of the half-shells 1a, 1b adjacent to the outside of the channel 5 is constant over the entire length of the channel 5. Regardless of the material of the half-shells 1a, 1b and the design of the joints 13, 15, 17, the mutually facing end faces of the half-shells 1a, 1b, which are connected to one another in pairs by one of the joints 13, 15, 17, are designed, for example, as planar surfaces. This design, which is shown as an example in FIGS. 4 and 5 and can also be used analogously in the other embodiments, offers the advantage that the half-shells 1a, 1b are of the same shape. This reduces the variety of parts in the measuring cell 100. This offers the advantage, in particular when producing larger quantities, of reducing storage and production costs.

Alternatively, the half-shells 1a, 1b, for example, are designed such that, on their mutually facing end faces, they have mutually complementary alignment elements 23, 25, which engage with a positive connection when the two half-shells 1a, 1b rest on one another in such a way that the recesses 3a, 3b forming one half of the channel 5 each are adjacent to one another with an exact fit. This embodiment, which is shown as an example in FIGS. 1 and 6 and can also be used analogously in the other embodiments, offers the advantage that it ensures a highly precise alignment of the half-shells 1a, 1b relative to one another, particularly during the production of the joints 13, 15, 17.

For example, mutually complementary plug elements, such as projections provided on one of the two half-shells 1a, are suitable as mutually complementary alignment elements 23, 25, which projections can be inserted into complementary recesses of the other half-shell 1b with a positive connection. One embodiment of this is that the projections are designed as webs arranged parallel to the outer contour of the channel 5, offset from the outer contour, which webs can be inserted and/or are inserted with a positive connection into complementary recesses designed as grooves in the corresponding other half-shell 1b. A further embodiment of this is that the projections are designed as dowel pins which can be inserted and/or are inserted with a positive connection into complementary recesses designed as bores in the corresponding other half-shell 1b. Analogously, projections of a different shape and complementary recesses can also be used.

Alternatively, the alignment of the half-shells 1a, 1b relative to one another can also be achieved by clamping the half-shells 1a, 1b during the joining process.

The measuring cell 100 comprises at least one transparent window adjacent to the measuring portion 7 through which optical measurements of a parameter of a medium located in the measuring portion 7 can be carried out. The transparency of the windows is to be understood with regard to optical measurements that can be carried out with the measuring cell 100 in such a way that each window through which transmitted radiation is transmitted into the measuring portion 7 during measuring operation is transparent at least in the wavelength range of the transmitted radiation, and each window through which measurement radiation emerging from the measuring portion 7 resulting from an interaction with a medium located in the measuring portion 7 is received during measuring operation is transparent at least in the wavelength range of the measurement radiation. Analogously, each window through which transmitted radiation is transmitted into the measuring portion 7 and measurement radiation emerging from the measuring portion 7 is received is designed as a window transparent in the wavelength range of the transmitted radiation and in the wavelength range of the measurement radiation. Depending on the type of parameter, the wavelength ranges of the transmitted radiation and the measurement radiation can be identical, at least partially overlapping, or different.

A first embodiment variant consists in the fact that the or each window is formed as an individual part from a transparent material, such as glass, quartz glass, sapphire or a transparent plastics material. In this embodiment variant, each window is enclosed in one of the two half-shells 1a, 1b, with or without the interposition of a seal without a gap, in such a way that it seals with the front flush on an inner surface of the corresponding half-shell 1a, 1b adjacent to the measuring portion 7 of the channel 5.

FIGS. 1 and 2 show embodiments of the first embodiment variant, in which the measuring cell 100 has two windows 27, 29 adjacent to the measuring portion 7 on opposite sides of the measuring portion 7, which windows are each inserted with the front flush into a passage opening running through one of the half-shells 1a, 1b without the interposition of a seal, by means of a press fit.

In the embodiment shown in FIG. 1, each window 27 is designed as a cylindrical element which is inserted by means of the press fit into the passage opening of one of the two half-shells 1a, 1b, the passage opening connecting to the measuring portion 7 and being, for example, also cylindrical. In conjunction with cylindrical windows 27, the half-shells 1a, 1b are preferably made of a soft material, such as a plastics material. In this case, the windows 27 consist, for example, of a transparent material, such as glass, sapphire or quartz glass, which is harder than the material of the half-shells 1a, 1b.

In the embodiment shown in FIG. 2, each window 29 is designed as a conical element which, here too, is inserted without the interposition of a seal by means of the press fit without any gap into the passage opening, which is also conical and opens into the measuring portion 7, of one of the two half-shells 1a, 1b. The conical shape of the windows 29 is particularly advantageous when the half-shells 1a, 1b are made of a harder material, such as a metal or a stainless steel. Here too, the windows 29 are preferably made of a transparent material, such as sapphire or quartz glass, which is harder than the material of the half-shells 1a, 1b.

Alternatively, instead of the windows 27, 29 shown in FIGS. 1 and 2, at least one window having a different shape can be inserted without a gap into one of the half-shells 1a, 1b without the interposition of a seal, by means of a press fit, without any gap. For this purpose, windows with a shape suitable for creating the press fit, such as windows with an elliptical, rectangular or square base surface, are suitable.

FIGS. 6 and 7 show further embodiments of the first embodiment variant, in which the half-shells 1a, 1b are designed as injection-molded parts, and the or each window 31, 33 is designed as an element overmolded during the production of one of the half-shells 1a, 1b.

This embodiment offers the advantage that the production of the half-shells 1a, 1b and the overmolding of the windows 31, 33 can be or is carried out in a single work step during the manufacture of the measuring cell 100.

A further advantage is that the shape of the windows 31, 33 can be freely selected within wide limits. In this case, the windows 31, 33 can also be designed, for example, as substantially cylindrical or conical elements or have another overmoldable shape, such as a shape with an elliptical, rectangular or square base surface.

Alternatively or additionally, each overmolded window 31, 33 may each have at least one outwardly projecting bulge 35 and/or at least one notch 37 on the outside.

FIG. 6 shows an embodiment in which each window 31 has a cylindrical region and at least one outwardly projecting bulge 35 surrounding the cylindrical region on all sides.

FIG. 7 shows a further embodiment in which each window 33 has a cylindrical region which has at least one or more notches 37 on the outside, each designed as annular circumferential grooves.

Regardless of the number and shape of the bulges 35 and/or notches 37, each bulge 35, as well as each notch 37 of the window 31, 33, offers the advantage that the compressive strength of the mechanical connection created by the overmolding between the respective windows 31, 33 and the half-shells 1a, 1b is increased.

Alternatively, instead of the first embodiment variant described above with reference to FIGS. 1, 2, 6 and 7, a second embodiment variant can be used in which the half-shells 1a, 1b consist of a transparent material and each window 39 is formed by a region of one of the two half-shells 1a, 1b adjacent to the measuring portion 7. An exemplary embodiment of this is shown in FIG. 4. In this embodiment, the transparent half-shells 1a, 1b consist, for example, of a transparent plastics material, such as polycarbonate (PC) or cyclo-olefin copolymer (COC) or of another transparent material, such as glass or quartz glass.

Measuring cells 100 according to the second embodiment variant offer the advantage over measuring cells 100 according to the first embodiment variant that they have even fewer components and the production of the windows 27, 29, 31 and 33 as individual parts, which is required in the production of measuring cells 100 according to the first embodiment variant, is omitted.

In the production of measuring cells 100 designed in the manner previously described with reference to FIGS. 1 to 8, the process is preferably carried out in such a way that the half-shells 1a, 1b are produced and then connected to one another by a joining process with which the joints 13, 15 and 17, respectively, adjacent to the channel 5 on both sides of the channel 5 are produced.

The production of measuring cells 100 according to the first embodiment variant further comprises a method step in which the windows 27, 29, 31 and 33 are prefabricated and are either overmolded during the production of the half-shells 1a, 1b or are inserted into the passage openings of the associated half-shells 1a, 1b by means of a press fit after the production of the half-shells 1a, 1b before the joining process is carried out.

The measuring cells 100 described here are used, for example, in measuring apparatuses for the optical measurement of at least one parameter of a medium. An exemplary embodiment of such a measuring apparatus 200 is shown in FIG. 9. The illustrated measuring apparatus 200 comprises a measuring cell receptacle 41, such as a housing or a holder, into which the measuring cell 100 can be inserted or is inserted, and a sensor 43 for measuring at least one parameter of the medium located in the measuring portion 7 of the channel 5 of the measuring cell 100 or flowing through the measuring portion 7.

Optical sensors known from the prior art are particularly suitable as the sensor 43. In this respect, the sensor 43 is designed, for example, as an optical sensor, as a turbidity sensor for measuring turbidity of the medium, as a sensor for measuring a solids concentration in the medium, as a fluorescence sensor, or as an absorption sensor, for example as a sensor for measuring a spectral absorption of the medium at one or more wavelengths, or a concentration of an analyte in the medium.

The sensor 43, shown in FIG. 9 merely as a possible embodiment, comprises a transmitting device 45 and a measuring device 47.

The transmitting device 45 comprises at least one radiation source, in particular a light source, a UV light source, an IR light source and/or a light-emitting diode, and is designed and arranged such that, during measuring operation, it transmits transmitted radiation through a window 27, 29, 31, 33, 39 of the measuring cell 100 into the measuring portion 7.

The measuring device 47 comprises, for example, a detector 49 which is designed and arranged in such a way that, during measuring operation, it receives measurement radiation emerging through a window 27, 29, 31, 33, 39 of the measuring cell 100 resulting from an interaction of the transmitted radiation with the medium located in the measuring portion 7 and determines and provides a parameter-dependent measuring signal Id.

Optionally, the sensor 43 can additionally comprise an evaluation device 51 integrated in the measuring device 47 or connected to the measuring device 47, via which, based on the measurement signals 1a output by the detector 49, a measuring result m of the parameter(s) is determined and displayed via an interface 53 connected thereto, output in the form of measured values, in the form of measuring signals and/or in another way, and/or provided in readable form.

Depending on the type of sensor 43 and/or the parameter(s), it may be sufficient for the measuring cell 100 to have only a single window 27, 29, 31, 33, 39 adjacent to the measuring portion 7 of the channel 5. In the illustrated embodiments, the measuring cell 100 has two windows 27, 29, 31, 33, 39 adjacent to the measuring portion 7 on opposite sides of the measuring portion 7. In this embodiment, the transmitting device 45 transmits the transmitted radiation through one of the two windows 27, 29, 31, 33, 39 into the measuring portion 7 and the measuring device 47 receives the measurement radiation emerging from the measuring portion 7 through the other window 27, 29, 31, 33, 39.

Accordingly, an optical path running through the measuring portion 7, along which the interaction with the medium takes place, has a length equal to a distance d between the two windows 27, 29, 31, 33, 39 of the measuring cell 100.

The length of the optical path can be specified within wide limits by the dimensions of the recesses 3a, 3b in the half-shells 1a, 1b. Accordingly, for different measuring tasks in which optical paths of different lengths are required or at least advantageous, measuring cells 100 with a correspondingly dimensioned distance d of the windows 27, 29, 31, 33 can be used. The dimensions of the recesses 3a, 3b are such that the distance d between the windows 27, 29, 31, 33, 39 lies in a distance range of 0.5 mm to 20 mm.

There are measuring tasks where a short optical path length is required or at least advantageous. An example of this is absorption measurements of highly absorbent media, for which short optical path lengths are used in order to be able to receive measurement radiation of sufficiently high intensity. In order to achieve correspondingly short optical path lengths, the windows 27, 29, 31, 33, 39 are arranged at a small distance d from one another, such as a distance d in a distance range from 0.5 mm to 10 mm, from 0.5 mm to 8 mm, from 0.5 mm to 5 mm or even only from 0.5 mm to 3 mm.

The measuring cells 100 described here offer the advantage that even very small distances d between the windows 27, 29, 31, 33, 39 can be realized without causing significant disturbances to the laminar flow, such as eddies and/or turbulence, without causing damage to the medium caused by shear forces, and/or without causing significant mixing of volumes of the medium entering the measuring cell 1 one after the other. A further advantage is that the distance d of the windows 27, 29, 31, 33, 39 can be predetermined by the shape of the recesses 3a, 3b independently of the inner diameter of the outer channel portions 9, and thus can be or is easily smaller than the inner diameter of the outer channel portions 9.

1. A measuring cell for a measuring apparatus for optically measuring a parameter of a medium, the measuring cell comprising:
two half-shells; and
at least one window, wherein:
the half-shells each have a recess on their mutually facing inner sides, and the adjacent, opposite recesses each form one half of a channel running through the measuring cell,
the channel has a measuring portion arranged in a direction running parallel to a longitudinal axis of the channel between two outer channel portions of the channel and is connected to each outer channel portion by a connecting portion of the channel designed as a cross-section converter,
the half-shells are connected to one another by two joints arranged on opposite sides of the channel and directly adjacent to the channel over the entire length of the channel, and
the at least one window is either formed by a transparent region of one of the half-shells adjacent to the measuring portion or is enclosed in one of the half-shells without any gap, with or without the interposition of a seal, in such a way that the at least one window seals with the front flush on an inner surface of the corresponding half-shell adjacent to the measuring portion of the channel.

2. The measuring cell according to claim 1, wherein the half-shells:
are designed as one-piece elements,
are made of metal, stainless steel, plastics material, polyetheretherketone, polyphenylenesulfone or a transparent material, polycarbonate, cyclo-olefin copolymer, glass or quartz glass, and/or
are designed as injection-molded parts or as 3D-printed parts.

3. The measuring cell according to claim 1, wherein:
a) on both sides of the channel, the end faces of the two half-shells which are adjacent to one another in pairs, are connected to one another by means of adhesives, ultrasonic welding or friction welding, or by joints made with a thermal joining process,
b) the two joints adjacent to the outside of the channel on both sides are each formed as laser welds produced by a laser introduced into the channel, or
c) each of the joints adjacent to the channel on the outside on both sides is designed as a joint produced from the outside of the measuring cell, as a joint produced from the outside of the measuring cell by means of a thermal joining process, or as a weld or laser weld produced from the outside of the measuring cell with a welding device, which extends as far as the channel.

4. The measuring cell according to claim 3, wherein each of the joints adjacent to the channel on both sides is designed as a joint produced from the outside of the measuring cell, wherein:
the end faces connected in pairs by the joints produced from the outside have a width running perpendicular to the longitudinal axis of the channel which is less than or equal to a maximum width predetermined depending on the material of the half-shells and the joining process used, which is dimensioned such that the joints produced from the outside are adjacent to the channel in the interior of the measuring cell, and/or
the half-shells have recesses which are adjacent to their end faces on the outside and are dimensioned such that the width of the end faces of the half-shells which are adjacent to the channel on the outside is constant and/or less than or equal to the maximum width over the entire length of the channel.

5. The measuring cell according to claim 4, wherein:
the two half-shells are designed as half-shells of the same shape, the end faces of which are connected to one another in pairs by one of the joints and are designed as planar surfaces, or
the two half-shells have, on their mutually facing end faces, mutually complementary alignment elements, or alignment elements designed as mutually complementary plug-in connector elements that engage with a positive connection when the two half-shells rest on one another such that the recesses forming one half of the channel each are adjacent to one another with an exact fit.

6. The measuring cell according to claim 1, wherein
the outer channel portions have identical circular cross-sectional areas and/or cross-sectional areas of constant size in the direction running parallel to the longitudinal axis of the channel, and/or have an inner diameter in the range of 2 mm to 26 mm,
the connecting portions are designed such that their cross-sectional area, in a direction running parallel to the longitudinal axis of the channel from the outer channel portion adjacent to the corresponding connecting portion to the measuring portion, continuously transitions from the cross-sectional area of the adjacent outer channel portion into a cross-sectional area of the adjacent measuring portion, and/or
the measuring portion has a shape permitting laminar flow, has a shape free of dead spaces and/or has a cross-sectional area which does not change at all or at least only changes continuously in the direction running parallel to the longitudinal axis of the channel.

7. The measuring cell according to claim 1, wherein a cross-sectional area of the channel in the direction running parallel to the longitudinal axis of the channel has a constant size over the entire length of the channel.

8. The measuring cell according to claim 1, wherein the at least one window includes two windows arranged opposite one another on both sides of the measuring portion, wherein the windows are arranged at a distance from one another which:
corresponds to a path length of an optical path running through the measuring portion,
is within a distance range from 0.5 mm to 20 mm, and/or
is smaller than an inner diameter of the outer channel portions.

9. The measuring cell according to claim 8, in which each window is formed as an individual part from a transparent material, from glass, from quartz glass, from sapphire or from a transparent plastics material, and is inserted with the front flush by a press fit into a passage opening of one of the half-shells adjacent to the measuring portion.

10. The measuring cell according to claim 9, wherein:
a) each window is designed as a cylindrical element or as an element having a shape that can be installed by a press fit, and the half-shells are made of plastics material, or
b) each window is designed as a conical element or as an element having a shape that can be installed by a press fit and is made of sapphire or of a transparent material that is harder than a metal or a stainless steel from which the half-shells are made.

11. The measuring cell according to claim 8, in which the half-shells are formed as injection-molded parts and each window is formed as an individual part made of glass, quartz glass, sapphire, or a transparent material and overmolded during the production of one of the half-shells.

12. The measuring cell according to claim 11, wherein each window:
a) is designed as an overmolded and/or substantially cylindrical or conical element,
b) has at least one bulge projecting on the outside and/or surrounding a cylindrical region of the window on all sides, and/or
c) has at least one notch on the outside and/or comprises a cylindrical region which has at least one or more notches on the outside, each designed as an annular circumferential groove.

13. A method for producing a measuring cell having two half-shells and at least one window, wherein the half-shells each have a recess on their mutually facing inner sides, and the adjacent, opposite recesses each form one half of a channel running through the measuring cell, the channel has a measuring portion arranged in a direction running parallel to a longitudinal axis of the channel between two outer channel portions of the channel and is connected to each outer channel portion by a connecting portion of the channel designed as a cross-section converter, the half-shells are connected to one another by two joints arranged on opposite sides of the channel and directly adjacent to the channel over the entire length of the channel, and the at least one window is either formed by a transparent region of one of the half-shells adjacent to the measuring portion or is enclosed in one of the half-shells without any gap, with or without the interposition of a seal, in such a way that the at least one window seals with the front flush on an inner surface of the corresponding half-shell adjacent to the measuring portion of the channel, the method comprising:
producing the half-shells; and
connecting the two half-shells to one another by a joining process with which the joints adjacent to the channel are produced.

14. The method according to claim 13, in which the at least one window is prefabricated and is either over-molded during the production of the half-shells designed as an injection-molded part or is inserted into the passage openings of the half-shells by a press fit after the production of the half-shells before the joining process is carried out.

15. A measuring apparatus, comprising:
a measuring cell, including:
two half-shells; and
at least one window, wherein:
the half-shells each have a recess on their mutually facing inner sides, and the adjacent, opposite recesses each form one half of a channel running through the measuring cell,
the channel has a measuring portion arranged in a direction running parallel to a longitudinal axis of the channel between two outer channel portions of the channel and is connected to each outer channel portion by a connecting portion of the channel designed as a cross-section converter,
the half-shells are connected to one another by two joints arranged on opposite sides of the channel and directly adjacent to the channel over the entire length of the channel, and
the at least one window is either formed by a transparent region of one of the half-shells adjacent to the measuring portion or is enclosed in one of the half-shells without any gap, with or without the interposition of a seal, in such a way that the at least one window seals with the front flush on an inner surface of the corresponding half-shell adjacent to the measuring portion of the channel;
a measuring cell receptacle into which the measuring cell can be inserted or is inserted; and
a sensor for measuring at least one parameter of the medium located in the measuring portion of the channel of the measuring cell or flowing through the measuring portion,
wherein the sensor:
a) is designed as an optical sensor, as a turbidity sensor, as a sensor for measuring a solids concentration in the medium, as a fluorescence sensor, as an absorption sensor, as a sensor for measuring a spectral absorption of the medium at one or more wavelengths, or a concentration of an analyte in the medium, and/or
b) comprises a transmitting device and a measuring device, wherein:
the transmitting device comprises at least one radiation source and is designed and arranged such that, during measuring operation, it transmits transmitted radiation through a window of the measuring cell into the measuring portion, and
the measuring device comprises a detector which is designed and arranged in such a way that, during measuring operation, it receives measurement radiation emerging through a window of the measuring cell resulting from an interaction of the transmitted radiation with the medium located in the measuring portion and provides a parameter-dependent measurement signal to an evaluation device integrated in the measuring device or connected or connectable to the measuring device, which is designed to determine and provide a measuring result of the at least one parameter based on measuring signals.
